(19) United States
(12) Patent Application Publication
(10) Pub. No.: US 2011/0276155 A1
(43) Pub. Date: Nov. 10, 2011

(54) MEDIA PLAYBACK SETTINGS FOR PLAYLISTS

(75) Inventor: Aram Lindahl, Menlo Park, CA (US)

(73) Assignee: Apple Inc., Cupertino, CA (US)

(21) Appl. No.: 12/776,261

(22) Filed: May 7, 2010

(51) Int. Cl. G06F 17/00

(52) U.S. Cl. 700/94

(57) ABSTRACT

This is directed to selecting and associating media playback settings with playlists. A user may create a playlist from a library of media items, and associate one or more selected media playback settings with the playlist. The media playback items can include audio, image, and video files, for example, and the media playback settings can include, for example, cross-fading properties, volume properties, equalizer settings, sequential playback settings, and the like. When the user selects a playlist for playback, the media items of the playlist may be played back according to the media playback settings associated with the playlist.

### BACKGROUND

This relates to systems and methods for associating media playback settings with playlists of media items.

Electronic devices may be used to play back different types of media items. For example, electronic devices may be used to play audio files and/or video files. A user of an electronic device may direct the device to play one or more media items grouped into one or more playlists. The media items played by the electronic device may be freely obtained or purchased by the user. The media items that are accessible or owned by the user can form the user's media library. The songs may be locally stored in the electronic device. The media items may also be streamed from a remote source. For example, the media items may be streamed from a content provider or from a user's host device.

The user may create a playlist that may be associated with a subset of available media items that are of particular interest to the user for playback using the electronic device. The user may create one or more playlists using any suitable approach. For example, the user may create a playlist by selecting media items based on genre, name of artist, name of album, or other metadata values. As another example, the user may select individual media items or groups of media items to include in a playlist.

In some devices, media playback settings may be globally set and used while playing back all individual media items and all playlists. For example, a user can globally set the media playback properties of an electronic device such that the global settings apply to all playlists and media items that the electronic device plays. This may limit the user's ability to fully enjoy the playback of media items.

### SUMMARY OF THE DISCLOSURE

Systems, methods, and computer-readable media for associating media playback settings with playlists of media items are provided.

For example, in some embodiments, there is provided a method of media playback that may include identifying a first playlist having a first subset of media items. The method may also include associating a first media playback setting with the first playlist, and then applying the first media playback setting to the first subset of media items during play back of the first playlist. For example, the first media playback setting may include an equalizer setting, a volume level setting, a sequential setting, or a transitional setting.

In other embodiments, there is provided a method for playing back playlists that may include identifying a playlist having a subset of media items selected from a media library and setting media playback characteristics for the playlist. The media playback characteristics may control at least the playback transitions between media items in the playlist.

In yet other embodiments, there is provided a method for playing back playlists that includes identifying media items available to a user, creating a first playlist having a first subset of the media items, and creating a second playlist having a second subset of the media items. The first and second subsets may be different. The method may also include associating a first set of media playback settings with the first playlist, associating a second set of media playback settings with the second playlist. The first set of media playback settings and the second set of media playback settings may be different. The method may also include playing back media items from one of the first and second playlists using the corresponding set of media playback settings associated with the one of the first and second playlists.

In yet still other embodiments, there is provided an electronic device for playing back media items. The electronic device may include a storage module configured to store media items and a first playlist having a first subset of the media items. The device may also include a settings module configured to store a first set of media playback characteristics. The first set of media playback characteristics may be associated with the first playlist. The device may also include a control module configured to retrieve the first playlist from the storage module, retrieve the first set of media playback characteristics from the settings module, and play back the retrieved first playlist using the retrieved set of playback characteristics.

In yet still other embodiments, there is provided computer readable media for controlling an electronic device. The media may include computer readable code recorded thereon for identifying a first playlist comprising a first subset of media items, associating a first media playback setting with the first playlist, and applying the first media playback setting to the first subset of media items during playback of the first playlist.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a schematic view of an electronic device in accordance with some embodiments of the invention;

FIG. 2 is a schematic view of an illustrative communications system including an electronic device and a host device in accordance with some embodiments of the invention;

FIG. 3 is a schematic view of an illustrative system for associating media playback settings with a playlist in accordance with some embodiments of the invention;

FIG. 4A is a schematic view of an illustrative display for defining a playlist in accordance in accordance with some embodiments of the invention;

FIG. 4B is a schematic view of an illustrative display for creating a smart playlist in accordance with some embodiments of the invention;

FIG. 5 is a flowchart of an illustrative process for associating media playback settings with playlists in accordance with some embodiments of the invention;

FIG. 6 is a flowchart of an illustrative process for associating media playback settings with playlists in accordance with some other embodiments of the invention; and

FIG. 7 is a flowchart of an illustrative process for associating media playback settings with playlists in accordance with some other embodiments of the invention.

### DETAILED DESCRIPTION OF THE DISCLOSURE

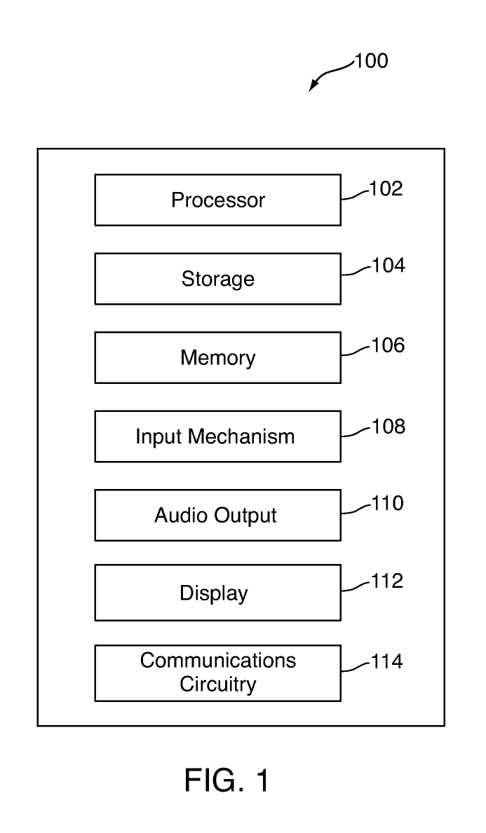

FIG. 1 is a schematic view of an electronic device 100 in accordance with some embodiments of the invention. Electronic device 100 may include processor 102, storage 104, memory 106, input mechanism or interface 108, audio output 110, display 112, and communications circuitry 114. In some embodiments, one or more of the electronic device components of device 100 may be combined or omitted (e.g., storage 104 and memory 106 may be combined, or communications circuitry 114 may be omitted). In some embodiments, electronic device 100 may include other components not combined or included in those shown in FIG. 1 (e.g., a power supply or a bus), or several instances of the components shown in FIG. 1. For the sake of simplicity, only one of each of the components are shown in FIG. 1.

Processor 102 may include any processing or control circuitry operative to control the operations and performance of electronic device 100. For example, processor 102 may be used to run operating system applications, firmware applications, media playback applications, media editing applications, or any other application. In some embodiments, processor 102 may drive outputs, such as audio output 110 and/or display 112, and process inputs received from a user interface, such as input mechanism 108.

Storage 104 may include, for example, one or more storage mediums including a hard-drive, solid state drive, flash memory, permanent memory such as ROM, any other suitable type of storage component, or any combination thereof. Storage 104 may store, for example, media data (e.g., media files such as music and video files), application data (e.g., for implementing functions on device 100), firmware, user preference information data (e.g., media playback preferences), authentication information (e.g. libraries of data associated with authorized users), lifestyle information data (e.g. food preferences), exercise information data (e.g. information obtained by exercise monitoring equipment), transaction information data (e.g., information such as credit card information), wireless connection information data (e.g., information that may enable electronic device 100 to establish a wireless connection), subscription information data (e.g. information that keeps track of podcasts or television shows or other media a user subscribes to), contact information data (e.g., telephone numbers and email addresses), calendar information data, and any other suitable data or any combination thereof.

Memory 106 can include cache memory, semi-permanent memory such as RAM, and/or one or more different types of memory used for temporarily storing data. In some embodiments, memory 106 can also be used for storing data used to operate electronic device applications, or any other type of data that may be stored in storage 104. In some embodiments, memory 106 and storage 104 may be combined as a single storage medium.

Input mechanism or interface 108 may provide inputs to input/output circuitry of the electronic device. Input interface 108 may include any suitable input interface, such as for example, a button, keypad, dial, a click wheel, or a touch screen. In some embodiments, electronic device 100 may include a capacitive sensing mechanism, or a multi-touch capacitive sensing mechanism.

Audio output 110 may include one or more speakers (e.g., mono or stereo speakers) built into electronic device 100, or an audio connector (e.g., an audio jack or an appropriate Bluetooth™ connection) operative to be coupled to an audio output mechanism. For example, audio output 110 may be operative to provide audio data using a wired or wireless connection to a headset, headphones, or earbuds.

Display 112 may include display circuitry (e.g., a screen or projection system) for providing a display visible to the user. For example, display 112 may include a screen (e.g., an LCD screen) that is incorporated in electronic device 100. As another example, display 112 may include a movable display or a projecting system for providing a display of content on a surface remote from electronic device 100 (e.g., a video projector). In some embodiments, display 112 can include a coder/decoder (Codec) to convert digital media data into analog signals. For example, display 112 (or other appropriate circuitry of electronic device 100) may include video Codecs, audio Codecs, or any other suitable type of Codec.

Display 112 also can include display driver circuitry, circuitry for driving display drivers, or both. Display 112 may be operative to display content (e.g., media playback information, application screens for applications implemented on the electronic device, information regarding ongoing communications operations, information regarding incoming communications requests, or device operation screens) under the direction of processor 102.

One or more of input interface 108, audio output 110, and display 112 may be coupled to input/output circuitry (not shown). The input/output circuitry may be operative to convert (and encode/decode, if necessary) analog signals and other signals into digital data. In some embodiments, the input/output circuitry can also convert digital data into any other type of signal, and vice-versa. For example, the input/output circuitry may receive and convert physical contact inputs (e.g., from a multi-touch screen), physical movements (e.g., from a mouse or sensor), analog audio signals (e.g., from a microphone), or any other input. The digital data can be provided to and received from processor 102, storage 104, memory 106, or any other component of electronic device 100. In some embodiments, several instances of the input/output circuitry can be included in electronic device 100.

Communications circuitry 114 may be operative to communicate with other devices or with one or more servers using any suitable communications protocol. Electronic device 100 may include one more instances of communications circuitry for simultaneously performing several communications operations using different communications networks. For example, communications circuitry may support Wi-Fi (e.g., a 802.11 protocol), Ethernet, Bluetooth™, radio frequency systems, cellular networks (e.g., GSM, AMPS, GPRS, CDMA, EV-DO, EDGE, 3GSM, DECT, IS-136/TDMA, iDen, LTE or any other suitable cellular network or protocol), infrared, TCP/IP (e.g., any of the protocols used in each of the TCP/IP layers), HTTP, FTP, RTP, RTSP, SSH, Voice over IP (VOIP), any other communications protocol, or any combination thereof. In some embodiments, communications circuitry 114 may include one or more communications ports operative to provide a wired communications link between electronic device 100 and a host device. For example, a portable electronic device may include one or more connectors (e.g., pin connectors or USB connectors) operative to receive a cable coupling the portable electronic device to a host computer. Using software on the host computer (e.g. iTunes™ available from Apple Inc. of Cupertino, Calif.), the portable electronic device may communicate with the host computer.

In some embodiments, electronic device 100 may include a bus operative to provide a data transfer path for transferring data to, from, or between control processor 102, storage 104, memory 106, input interface 108, audio output 110, display 112, communications circuitry 114, and any other component included in the electronic device.

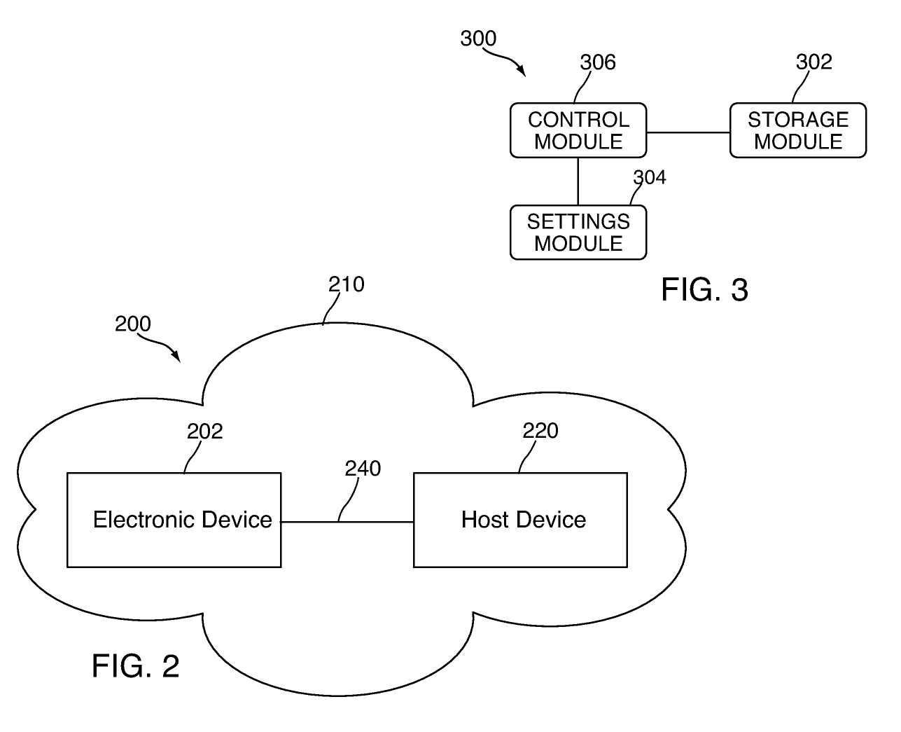

Electronic device 100 can store some or all of a user's media library. For example, the entirety of the user's media library can be located in storage 104. Alternatively, the user's media library can be hosted by another device, and particular media items of the user's library may be synched to electronic device 100. FIG. 2 is a schematic view of an illustrative communications system 200 including an electronic device 202 and a host device 220 in accordance with some embodiments of the invention. Communications system 200 may include electronic device 202 and communications network 210, which electronic device 202 may use to perform wired or wireless communications with other devices within communications network 210. For example, electronic device 202 may perform communications operations with host device 220 over communications network 210. Although communications system 200 may include several electronic devices 202 and host devices 220, only one of each is shown in FIG. 2 to avoid overcomplicating the drawing.

Any suitable circuitry, device, system or combination of these (e.g., a wireless communications infrastructure including communications towers and telecommunications servers) operative to create a communications network may be used to create communications network 210. Communications network 210 may be capable of providing wireless communications using any suitable short-range or long-range communications protocol. In some embodiments, communications network 210 may support, for example, Wi-Fi (e.g., a 802.11 protocol), Bluetooth™, radio frequency systems (e.g., 200 MHz, 2.4 15 GHz, and 5.6 GHz communication systems), infrared, protocols used by wireless and cellular telephones and personal email devices, or any other protocol supporting wireless communications between electronic device 202 and host device 220. Communications network 210 may instead or in addition be capable of providing wired communications between electronic device 202 and host device 220, for example using any suitable port on one or both of the devices (e.g., pin, USB, FireWire, Serial, or Ethernet).

Electronic device 202 may include any suitable device for receiving media or data. For example, electronic device 202 may include one or more features of electronic device 100 (FIG. 1). Electronic device 202 may be coupled with host device 220 over communications link 240 using any suitable approach. For example, electronic device 202 may use any suitable wireless communications protocol to connect to host device 220 over communications link 240. As another example, communications link 240 may be a wired link that is coupled to both electronic device 202 and host device 220 (e.g., an Ethernet cable). As still another example, communications link 240 may include a combination of wired and wireless links (e.g., an accessory device for wirelessly communicating with host device 220 may be coupled to electronic device 202). In some embodiments, any suitable connector, dongle, or docking station may be used to couple electronic device 202 and host device 220 as part of communications link 240.

Host device 220 may include any suitable type of device operative to host a media library and provide media files to electronic device 202. For example, host device 220 may include a computer (e.g., a desktop or laptop computer), a server (e.g., a server available over the Internet or using a dedicated communications link), a kiosk, or any other suitable device. Host device 220 may transfer media files of a media library to electronic device 202 using any suitable approach. In some embodiments, host device 220 can run an application dedicated to providing a communications interface between host device 220 and electronic device 202 (e.g., iTunes™). Using the application, a user can define the particular subset of media items from the user's media library to transfer to electronic device 202.

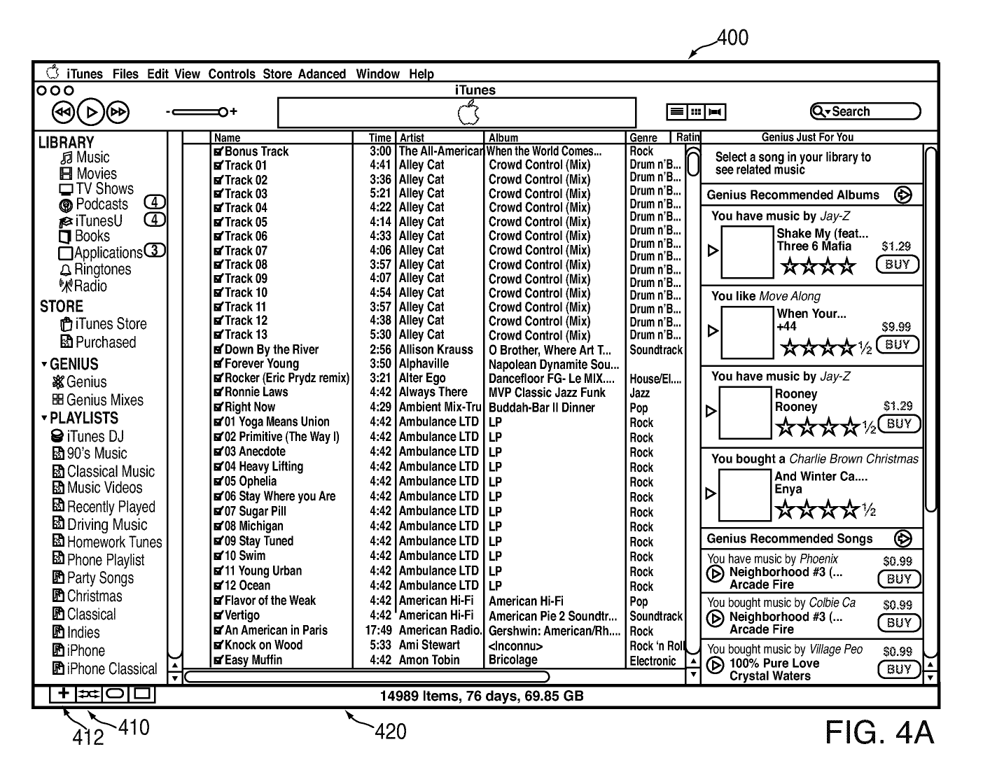

In some embodiments, a user may want to play back a subset of media items that are of particular interest to the user. As such, the user may create playlists. FIG. 3 is a schematic view of an illustrative system 300 for associating media playback settings with a playlist in accordance with some embodiments of the invention. System 300 may include storage module 302, settings module 304, and control module 306. Any suitable media available to the user can be stored or accessed through storage module 302. For example, storage module 302 may include media items available to a user (e.g., media streamed from remote sources), media items that are stored on a user's device, or combinations of these. In some embodiments, storage module 302 may also include one or more playlists. Storage module 302 can be provided as part of one or more devices, including for example, a host device on which a media library is stored, a portable device used to playback the media, or a remote source for media.

Settings module 304 can include any information controlling the manner in which media is played back. For example, settings module 304 may store media playback settings that may be associated with one or more playlists that may be stored in storage module 302, such as audio settings that may be associated with a particular playlist of particular media items. Any suitable media setting can be stored, including, for example, turning the cross-fade between media items on or off, choosing a particular type of cross-fade, or selecting the duration of a cross-fade. The media playback settings may also include turning the sound check on or off, adjusting the volume, selecting random playback or normal playback of items in the playlist, and choosing equalizer settings. Settings module 304 can be incorporated as a part of any one or more suitable devices, including, for example, one or more of the devices described in the context of storage module 302. For example, settings module 304 can be incorporated on the device used to play back media items to a user.

Control module 306 can retrieve information from storage module 302 and settings module 304, and can use the retrieved information to control media playback. Control module 306 can include one or more interfaces for retrieving the information from the other modules, and for directing output circuitry to provide a media output in accordance with settings retrieved from settings module 304. Control module 306 can be incorporated as a part of any one or more suitable devices, including, for example, the device used to play back media items to a user.

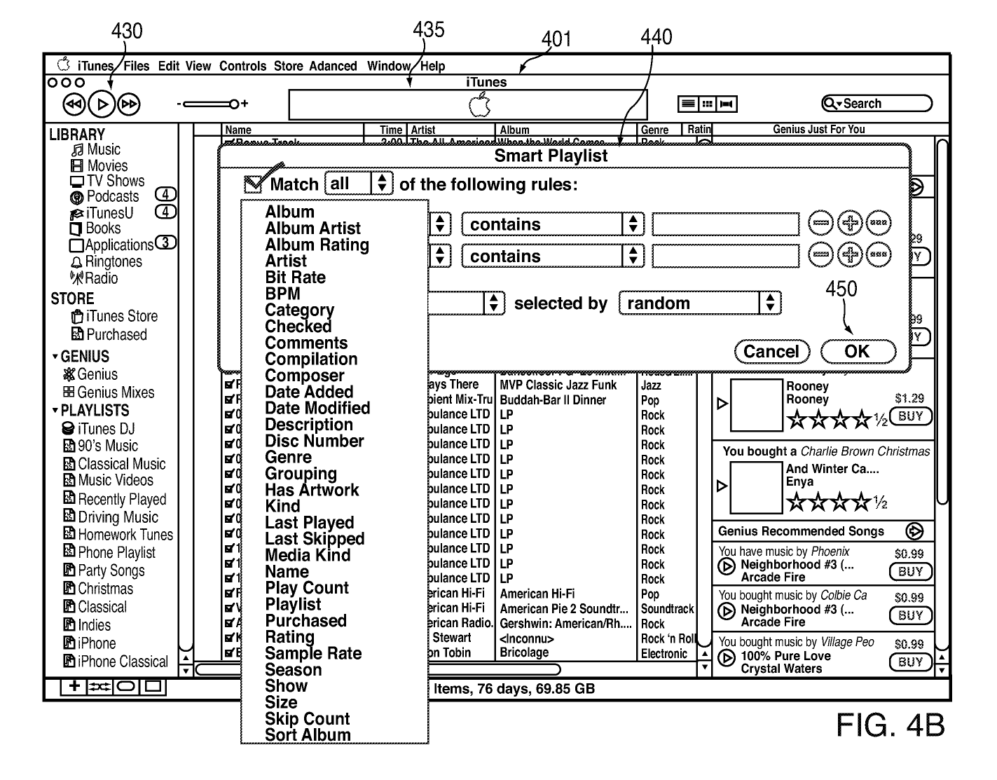

FIG. 4A is a schematic view of an illustrative display of a user interface that may be used to define a playlist in accordance with some embodiments of the invention. Display 400 may include options bar 410 and media region 420. Options bar 410 may include options for identifying different types of media available in a user's media library. For example, options bar 410 can include options for the user's media library, a media store, and playlists. In some embodiments, a user can use display 400 to form various collections of media items to play back (e.g., playlists). To create a playlist, a user can add a new playlist to options bar 410 (e.g., by selecting a corresponding option 412). To add a media item to the playlist, a user can select one or more media items from media region 420 to place in the playlist (e.g., by dragging and dropping). In some embodiments, a user can add media items to an existing playlist, or remove media items from a previously created playlist.

In some embodiments, a user can instead or in addition direct an electronic device to automatically generate a playlist based on user defined criteria. FIG. 4B is a schematic view of an illustrative display of a user interface that may be used to create a smart playlist in accordance with some embodiments of the invention. Display 401 can include options bar 430 and media region 435, which can include some or all of the features of the corresponding bar and region of display 400 (FIG. 4A). To create a smart playlist, the electronic device can display a pop-up menu, display, or box (e.g. menu 440) for defining rules that may be used to select one or more media items to be included in a playlist. Menu 440 can include any suitable options for defining one or more rule criteria for selecting media items. For example, a user can define rules corresponding to one or more metadata values (e.g., select a metadata category, a Boolean operation, or a value, where media items that have metadata corresponding to the category, value, and/or operation are to be included in the playlist). Upon defining one or more rules, a user can provide a selection instruction (e.g., “OK” option 450) to generate a smart playlist. The smart playlist can then be provided in options bar 430.

When the user directs an electronic device to play back one or more media items, the electronic device can use or apply any suitable media playback setting or set of media playback settings for playing back the media item or media items. The various types of media playback settings can include, for example, audio or video equalizer settings (e.g., pattern of attenuation or boost of various ranges of frequencies), volume level settings, speed settings, sound check settings, sequential settings (e.g., a repeat setting, a shuffle setting, a continuous loop setting, or various other ways in which the sequence of media items grouped in a playlist may be altered during playback of the playlist), transitional settings (e.g., a cross-fade setting, an animation setting, or various other ways in which the play back of two or more media items may transition between one another), or any other suitable media playback settings or properties or characteristics that may alter the way in which a media item or a set of media items may be played back and presented to a user. For example, varying the value of a first type of media playback setting may vary the amount of bass and/or treble of a media item, such as an audio file, that may be played back to a user. As another example, varying the value of another type of media playback setting may vary the speed at which a media item may be played back to a user. As another example, varying the value of another type of media playback setting may vary the brightness or other visual property with which a media item, such as a picture or video file, is played back or displayed to a user. As another example, varying the value of yet another type of media playback setting may vary the manner in which two or more media items are to transition from one to another during playback (e.g., the speed or duration of a cross-fade between two audio files and/or video files, the type of animation used to transition between two image files, and the like).

In some embodiments, an individual media item can be associated with specific values of one or more types of media playback settings, which can then be used to control the playback of the individual media item. For example, a user may interact with a user interface to select one or more specific values for one or more types of media playback settings and may then associate those specific selected settings with a particular individual media item. If a user would like to associate those specific selected settings with more than one media item (e.g., all media items in a specific playlist), it could be time consuming. Additionally or alternatively, for a particular media item that may be included in two or more different playlists, different playback settings may be desired for that particular media item depending upon the particular playlist in which the media item is currently being played back. Therefore, in other embodiments, one or more values of one or more media playback settings may be associated with a playlist and those playlist-specific settings may be applied to all media items in that playlist during playback of that playlist. For example, specific values of specific playback settings may be stored in metadata of the playlist or may be otherwise associated with the playlist such that when the playlist is being played back, the specific values of the specific playback settings may be applied to the media items of the playlist. Therefore, if a particular song is included in both a first playlist and a second playlist, and if the first playlist is associated with at least one different media playback setting than the second playlist, then the particular song shared by both playlists may be played back differently depending upon which playlist is currently being played back. Furthermore, if a particular song is included in a first playlist that is associated with a first media playback setting, but that particular song is not associated with the first media playback setting in its own right (i.e., independently from being included in the first playlist), then the particular song may be played back differently when it is played back on its own (i.e., without the first media playback setting) as compared to when it is played back as part of the first playlist (i.e., with the first media playback setting).

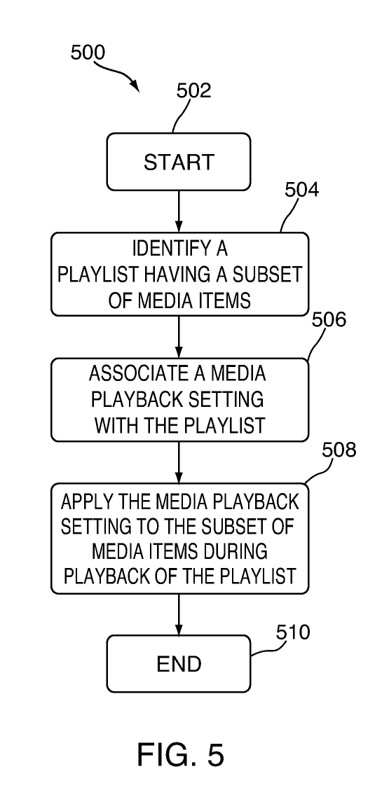

FIG. 5 is a flowchart of an illustrative process for associating media playback settings with playlists in accordance with some embodiments of the invention. Process 500 may begin at step 502. At step 504, an electronic device or a user may identify a playlist having a subset of available media items. The identified playlist may be selected at step 504 from one or more playlists available in a storage module, such as in a media library or a storage medium of an electronic device. Alternatively, the identified playlist may be created at step 504. After step 504, the user may modify the identified playlist using any suitable approach. For example, the user may modify defining characteristics of the playlist (e.g., genre, name of artist, name of album, or metadata values). As another example, a media item may be added or removed from the playlist. At step 506, the user may select and associate a media playback setting with the playlist. For example, the user can change an existing playback setting that was already associated with the playlist before its modification. As another example, the user can select a new playback setting to be associated with the playlist. These media playback settings may be used to determine the way in which media items of the playlist may be audibly and/or visually presented to the user. At step 508, the first media playback setting may be applied to the media items of the playlist during play back of the playlist (e.g., by the electronic device). Process 500 can then end at step 510.

It is understood that the steps shown in process 500 of FIG. 5 are merely illustrative and that existing steps may be modified or omitted, additional steps may be added, and the order of certain steps may be altered.

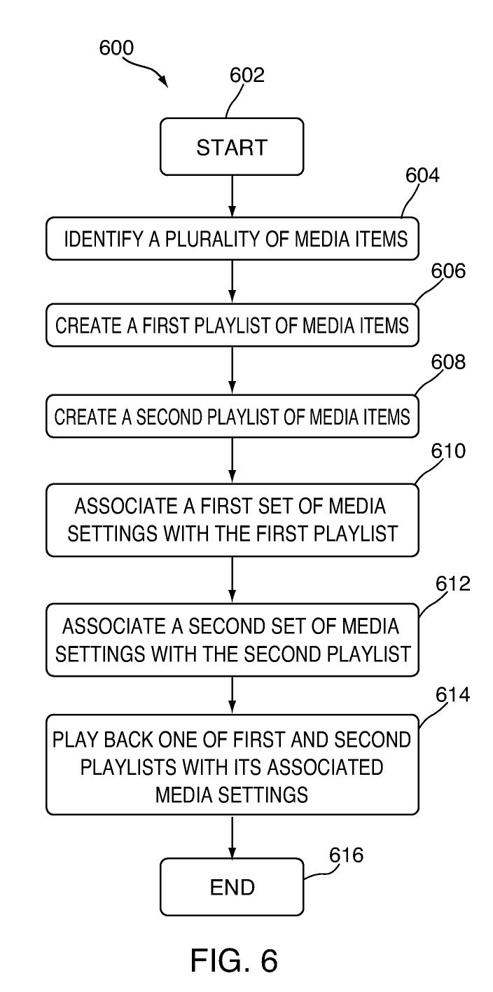

FIG. 6 is a flowchart of an illustrative process for associating media playback settings with playlists in accordance with some other embodiments of the invention. Process 600 may begin at step 602. At step 604, several media items available to the user can be identified. For example, the media items may be available in a storage module, such as in a media library or a storage medium of an electronic device. In some embodiments, an electronic device or module can identify one or more devices or sources for media items that the user is authorized to access (e.g., media items that the user has purchased). In some embodiments, an electronic device can retrieve copies of media items to store locally. At step 606, the electronic device may create a first playlist from the media items. For example, the electronic device can receive a selection of several media items to incorporate in a first playlist. At step 608, the electronic device may create a second playlist from the media items. For example, the electronic device can receive another selection of several media items to incorporate in a second playlist. The first and second playlists can be different, such that at least one media item is not in common between the two playlists. At step 610, the user may define a first set of media playback settings to be associated with the first playlist. At step 612, the user may define a second set of playback media settings to be associated with the second playlist. The first and second sets of media playback settings may be different, such that at least one setting differs between the two sets. At step 614, the electronic device may play back the first playlist or the second playlist with its corresponding set of media playback settings. For example, when the electronic device switches playback between the first playlist and the second playlist, the electronic device can automatically change the media playback settings used for media playback. Process 600 can then end at step 616.

It is understood that the steps shown in process 600 of FIG. 6 are merely illustrative and that existing steps may be modified or omitted, additional steps may be added, and the order of certain steps may be altered.

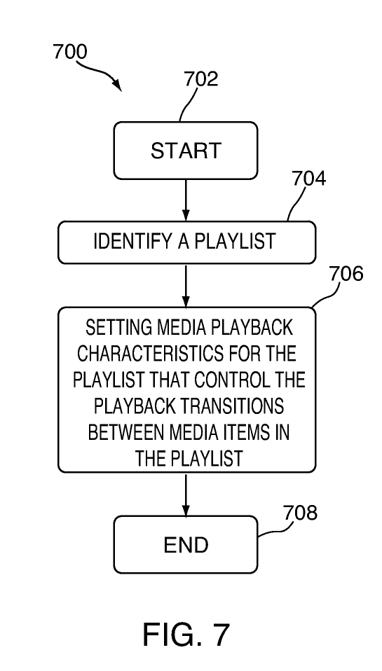

FIG. 7 is a flowchart of an illustrative process for adjusting media playback in accordance with some embodiments of the invention. Process 700 can begin at step 702. At step 704, a playlist can be identified. For example, a subset of media items selected from a media library can be grouped in a playlist that the user can play back. The playlist identified at step 704 may be created at step 704 or selected from a group of existing playlists at step 704. At step 706, media playback characteristics may be set form the playlist. This may be done by the electronic device (e.g., at the direction of a user, who may choose one or more specific values for the one or more media playlist characteristics). The media playback characteristics may control at least the transitions between media items in the playlist. The audio playlist characteristics can be retrieved by control circuitry playing back media items of the playlist and may be applied to the playback process. The transitions that may be controlled by one or more of the media playback characteristics may include a cross-fade setting, an animation setting, or various other ways in which the playback of two or more media items may transition between one another. Process 700 can then end at step 708.

It is understood that the steps shown in process 700 of FIG. 7 are merely illustrative and that existing steps may be modified or omitted, additional steps may be added, and the order of certain steps may be altered.

The processes described with respect to FIGS. 5-7, as well as any other aspects of the invention, may each be implemented by software, but can also be implemented in hardware or a combination of hardware and software. They each may also be embodied as computer readable code recorded on a computer readable medium. The computer readable medium may be any data storage device that can store data which can thereafter be read by a computer system. Examples of the computer readable medium include read-only memory, random-access memory, flash memory, CD-ROMs, DVDs, magnetic tape, and optical data storage devices. The computer readable medium can also be distributed over network-coupled computer systems so that the computer readable code is stored and executed in a distributed fashion.

Although many of the embodiments of the present invention are described herein with respect to personal computing devices, it should be understood that the present invention is not limited to personal computing applications, but is generally applicable to other applications.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above-described embodiments of the invention are presented for purposes of illustration and not of limitation.

What is claimed is:

1. A method of media playback comprising:
identifying a first playlist comprising a first subset of media items from a plurality of media items;
associating a first media playback setting with the first playlist; and
applying the first media playback setting to the first subset of media items during playback of the first playlist.

2. The method of claim 1, wherein the first media playback setting comprises one of an equalizer setting and a volume level setting.

3. The method of claim 1, wherein the first media playback setting comprises one of a sequential setting and a transitional setting.

4. The method of claim 1, wherein the first media playback setting affects the order in which the first subset of media items are played back.

5. The method of claim 1, wherein the first media playback setting affects the transition between the playback of a first media item in the first subset of media items and the playback of a second media item in the first subset of media items.

6. The method of claim 1, wherein the identifying the first playlist comprises a user creating the first playlist by selecting the first subset of media items from the plurality of media items.

7. The method of claim 1, wherein the identifying the first playlist comprises a user selecting an existing playlist as the first playlist.

8. The method of claim 1 further comprising:
associating a second media playback setting with the first playlist that is different than the first media playback setting; and
applying the first media playback setting and the second media playback setting to the first subset of media items during play back of the first playlist.

9. The method of claim 1 further comprising selecting a specific value of the first media playback setting before the associating.

10. The method of claim 1 further comprising:
identifying a second playlist comprising a second subset of media items from the plurality of media items that is different than the first subset of media items;
associating a second media playback setting with the second playlist that is different than the first media playback setting;
applying the second media playback setting to the second subset of media items during play back of the second playlist.

11. The method of claim 10, wherein the first subset of media items and the second subset of media items both share at least one media item in common.

12. A method for playing back playlists, comprising:
identifying a playlist comprising a subset of a plurality of media items selected from a media library; and
setting media playback characteristics for the playlist, wherein the media playback characteristics control at least the playback transitions between media items in the playlist.

13. The method of claim 12, wherein the media playback characteristics also control at least one of:
random playback of the media items in the playlist;
equalizer settings of the media items in the playlist;
cross-fading between media items in the playlist; and
volume levels of the media items in the playlist.

14. The method of claim 12 further comprising:
playing back a media item that is not in the subset of the plurality of media items; and
providing a default playback transition after the media item has been played back, wherein the default playback transition is different from the playback transition between media items in the playlist.

15. The method of claim 12, wherein the identifying the playlist comprises receiving a user selection of the subset of the media items.

16. The method of claim 12, wherein the identifying the playlist comprises:
receiving a user selection of metadata values corresponding to media items;
identifying a set of media items from the media library that includes the selected metadata values; and
assigning the set as the subset making up the playlist.

17. The method of claim 16, wherein at least one of the metadata values comprise at least one of genre, artist, album, year, rating, and composer.

18. A method for playing back playlists comprising:
identifying a plurality of media items available to a user;
creating a first playlist comprising a first subset of the plurality of media items;
creating a second playlist comprising a second subset of the plurality of media items, wherein the first and second subsets are different;
associating a first set of media playback settings with the first playlist;
associating a second set of media playback settings with the second playlist, wherein the first set of media playback settings and the second set of media playback settings are different; and
playing back media items from one of the first and second playlists using the corresponding set of media playback settings associated with the one of the first and second playlists.

19. The method of claim 18, wherein:
the first set of media playback settings comprises at least one of a cross-fade setting, an equalizer setting, a random playback setting, and a volume setting; and
the second set of media playback settings comprises at least one of a cross-fade setting, an equalizer setting, a random playback setting, and a volume setting.

20. An electronic device for playing back media items, comprising:
a storage module configured to store a plurality of media items and a first playlist comprising a first subset of media items of the plurality of media items;
a settings module configured to store a first set of media playback characteristics, wherein the first set of media playback characteristics is associated with the first playlist; and
a control module configured to:
retrieve the first playlist from the storage module;
retrieve the first set of media playback characteristics from the settings module; and
play back the retrieved first playlist using the retrieved set of playback characteristics.

21. The electronic device of claim 20, wherein the control module is further configured to:
receive an instruction to modify the first playlist;
direct the storage module to store the modified first playlist; and
associate the first set of media playback characteristics with the modified first playlist.

22. The electronic device of claim 20, wherein the control module is further configured to:
identify a media item to play back;
determine that the identified media item is not included in the first subset of media items; and
play back the identified media item using a default set of media playback characteristics in response to the determining, wherein the default set of media playback characteristics is different than the first set of media playback characteristics.

23. The electronic device of claim 20, wherein the control module is further configured to:
receive a request to play back a first media item, wherein the first subset of media items comprises the first media item;
determine that the received request is independent of the first playlist; and
play back the first media item using a default set of media playback characteristics, wherein the default set of media playback characteristics is different than the first set of media playback characteristics.

24. The method of claim 20, wherein at least one media playback characteristic of the first set of media playback characteristics comprises one of an equalizer characteristic, a volume level characteristic, a sequential characteristic, and a transitional characteristic.

25. Computer readable media for controlling an electronic device, comprising computer readable code recorded thereon for:
identifying a first playlist comprising a first subset of media items from a plurality of media items;
associating a first media playback setting with the first playlist; and
applying the first media playback setting to the first subset of media items during playback of the first playlist.
